(19) United States
(12) Patent Application Publication
(10) Pub. No.: US 2022/0326418 A1
(43) Pub. Date: Oct. 13, 2022

(54) HIGH ENERGY LASER SENSOR SUBSTRATE

(71) Applicant: SemQuest Inc., Colorado Springs, CO (US)

(72) Inventors: David J. Ward, Colorado Springs, CO (US); John LeSage, Colorado Springs, CO (US)

(73) Assignee: SemQuest, Colorado Springs, CO (US)

(21) Appl. No.: 17/655,249

(22) Filed: Mar. 17, 2022

Related U.S. Application Data
(60) Provisional application No. 63/171,764, filed on Apr. 7, 2021.

(51) Int. Cl. G02B 5/08; G02B 5/02

(52) U.S. Cl. CPC G02B 5/0808; G02B 5/0221

(57) ABSTRACT

A high energy laser target board substrate system having a substrate substantially transparent to one or more forms or radiation, includes a diffused first surface and a reflective layer with a transmissivity at a zero-degree angle of incidence greater than 0.0% with transmissivity decreasing thereafter as angle of incidence increases.

### RELATED APPLICATION

The present application relates to and claims the benefit of priority to U.S. Provisional Patent Application No. 63/171,764 filed 7 Apr. 2022 which is hereby incorporated by reference in its entirety for all purposes as if fully set forth herein.

### BACKGROUND OF THE INVENTION

### Field of the Invention

Embodiments of the present invention relate, in general, to sensor systems and more particularly to a high energy laser sensor substrate.

### Relevant Background.

High Energy Laser (HEL) devices have been increasingly utilized in various applications including destroying or burning a given target. However, development of HEL devices has outpaced the development of HEL detector/sensor technology. Indirect measurements of HEL irradiance (such as thermal sensors or remote optical/thermal imaging) have proven to be inaccurate and unreliable as have photo detector arrays in the direct path of HEL beams.

Laser system manufacturers and users of lasers have also long desired the ability to measure a laser beam's quality at some distance from the beam source. When a laser beam is used long distances from its source, the beam quality is reduced. Atmospheric properties such as aerosols, turbulence, and precipitation are primary factors, but problems located inside the laser source or beam director may also play a role. Knowledge of certain beam parameters can help laser system operators diagnose the source of beam quality reduction and better understand what can be done to mitigate learned problems.

Beam characteristics of interest include beam power, peak irradiance, beam diameter, and overall beam shape. Beam properties of these types can be difficult to measure because the beam power, as implied above, can be so large that it can damage the system designed to make measurements. Accordingly, measurement systems for laser beams must be designed specifically to account for the large beam power. For example, a calorimeter is designed to measure beam power for beam sizes less than its input aperture and absorption of most of the beam power is typically desired during measurement. In such an application, the device is either actively cooled by water or has a large thermal mass. Determination of power incident within the aperture can be made by monitoring the temperature of the thermal mass and/or water used for cooling. Without cooling, the system cannot be used continuously without overheating.

Another measurement system can be made from a scatter plate and camera. HEL beam illuminates a flat Lambertian reflecting target (scatter plate). A camera captures the reflected image of the beam after it diffusely reflects off the target. The camera, sitting outside the beams path, collects images and later uses post processing to account for any perspective variations caused by a non-ideal geometry. The life of these systems can be extended by spinning them, avoiding burning the plate by spreading out the generated heat into a larger surface area. Alternatively, an optical wedge can be used, reflecting, or refracting a small percentage of the beam energy onto the scatter plate, again prolonging the life of the scatter plate. But at long ranges or on a flying platform these systems can be difficult or impossible to construct and maintain.

A more recent technology is called a target board. A first set of requirements for these systems includes making them of low volume, light weight, and self-contained. Other requirements include the ability to make measurements of HEL beams having extremely high irradiance and elevated total power levels, continuously, with no duration or exposure limitations. It should be of no surprise that systems designed to meet these requirements reflect as much of the laser beam as possible. Higher reflectivity generally results in greater system survival and continuous laser engagement durations. As reflectivity is important, values greater than 99.9% are not uncommon and are quite often desired. Moreover, absorption within the substrate itself must be low.

As such, there is a need in the art for reliable and durable measuring spatial and temporal HEL irradiance at multi-kW power levels or higher levels in an outdoor environment. For HEL weapons utilized in moving military platforms, it is desirable for measurement system to be light-weight and robust to flight aerodynamics. There is also a need in the art for a low-cost intensity measurement system with reusability, ease of retrofit, simplicity in calibration, and scalability. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A high energy laser target board substrate system incorporates a highly reflective layer providing consistent reflective and accurate transmissive measurement characteristics. The substrate of the present invention is, in one embodiment, made of a material substantially transparent to one or more forms of radiation. In one instance, the substrate is highly polished glass or similar material having high purity with a low degree of absorption. The outward facing, or first surface of the substrate creates an air-substrate interface that, due to differences in the index of refraction, reflects a portion of the optical power back toward the laser source. This reflection, the magnitude of which is predicted by the Fresnel equations, as well as the reflection from the reflective layer may be dangerous, if not controlled. One aspect of the present invention diffuses the first surface thereby diminishing irradiance at the inverse square of the distance from the target board.

In one embodiment of the present invention, a high energy laser target board substrate system includes a substrate, transparent to one or more forms of radiation, which has a first surface and a second surface. The first surface is diffused with a reflective layer bonded to the second surface. The transmissivity of the reflective layer at a zero-degree angle of incidence is in one embodiment greater than 0.0% and less than 0.50%.

The one or more forms of radiation include energy traveling in the form of an electromagnetic wave and, in one instance, the electromagnetic waves have a wavelength between 1030 nm and 1080 nm. The one or more forms of radiation may also be represented as photons.

The one or more forms of radiation are, in another embodiment, reflected from the first surface of the substrate independent of an angle of incidence formed between the one or more forms radiation and the first surface of the substrate. In another embodiment the degree of roughness of the diffuse surface is based on the wavelength of the one or more forms of incoming radiation.

The substrate of the high energy laser target board substrate system of the present invention, in one embodiment, is comprised of amorphous silicon dioxide. The relative transmissivity of the reflective layer bonded to the second surface, normalized at the zero-degree angle of incidence, at an angle of incidence equal or greater than 25 degrees is, in one instance of the present invention, equal or less than 0.5. In another version of the present invention the relative transmissivity of the reflective layer at an angle of incidence equal to or greater than 45 degrees is equal to or less than 0.2. And in yet another version of the present invention the relative transmissivity of the reflective layer at an angle of incidence equal to or greater than 70 degrees is equal to or less than 0.1.

One method for manufacturing the high energy laser target board substrate system of the present invention begins with diffusing a first surface of a substrate, wherein the substrate is configured to be transparent to one or more forms of radiation. In one version of the present invention the substrate is amorphous silicon dioxide that is substantially transparent to electromagnetic waves having a wavelength between 1030 nm and 1080 nm. With the first surface diffused, the manufacturing process continues by bonding a reflective layer to a second (opposite) surface of the substrate. The transmissivity of the reflective layer at a zero-degree angle of incidence is greater than 0.0% and less than 0.50%.

Other steps in manufacturing the high energy laser target board substrate system of the present invention include configuring the relative transmissivity of the reflective layer, normalized at the zero-degree angle of incidence, at an angle of incidence equal or greater than 25 degrees to be equal or less than 0.5. In other versions of the present invention the relative transmissivity of the reflective layer is configured to be equal to or less than 0.2 at an angle of incidence equal to or greater than 45 degrees. And in yet another embodiment the relative transmissivity of the reflective layer is configured to be equal to or less than 0.1 at an angle of incidence equal to or greater than 70 degrees.

Another version of manufacturing the high energy laser target board substrate system of the present invention includes removing one or more portions of the reflective layer forming, at each portion, a transmission portal. The portals are configured to have transmissivity substantially larger than that of the reflective layer.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows cross-sectional view of a representative substrate exposed to an incoming source of radiation and the measurement of an angle of incidence between the surfaces of the substrate and the incoming source of radiation, as would be known to one of reasonable skill in the relevant art;

FIG. 2 is a representative showing of a substrate, as would be known to one of reasonable skill in the relevant art, having reflective layer possessing inconsistent transmissivity characteristics;

FIG. 3 is a graphical rendition of normalized transmissivity of a typical reflective surface, as would be known to one of reasonable skill in the relevant art;

FIG. 4 is a cross-sectional view of a high energy laser target board substrate system, according to one embodiment of the present invention;

FIG. 5 is a graphical rendition of normalized transmissivity of a high energy laser target board substrate system, according to one embodiment of the present invention, subjected to a plurality of wavelengths of radiation; and

FIGS. 6A and 6B show a flowchart of one methodology, according to the present invention, for manufacturing a high energy laser target board substrate system.

The Figures depict embodiments of the present invention for purposes of illustration only. Like numbers refer to like elements throughout. In the figures, the sizes of certain lines, layers, components, elements, or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A high energy laser target board system having a substrate substantially transparent to one or more forms or radiation, includes a diffused first surface and a reflective layer bonded to a second surface. The reflective layer is configured to have a transmissivity at a zero-degree angle of incidence greater than 0.0% and less than 0.50%.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

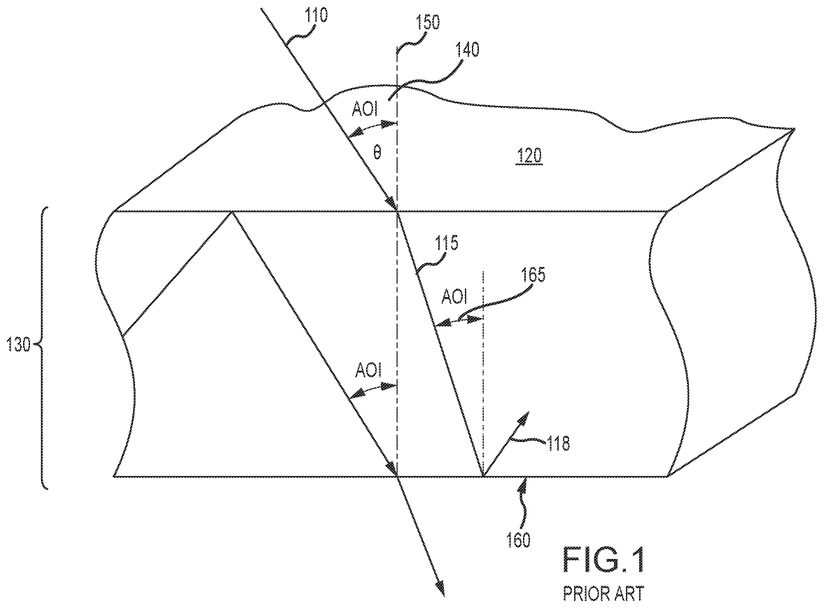

By the term “angle of incidence” it is meant the angle between a ray incident on a surface and the line perpendicular to the surface at the point of incidence, called the normal. The ray can be formed by any wave: optical, acoustic, microwave, X-ray and so on. As shown in FIG. 1, the line representing a ray makes an angle θ (AOI) with the normal (dotted line).

By the term “substrate” it is meant an underlying substance or layer. In optics the substrate is often glass or a similar substance through which radiation traverses.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with, or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

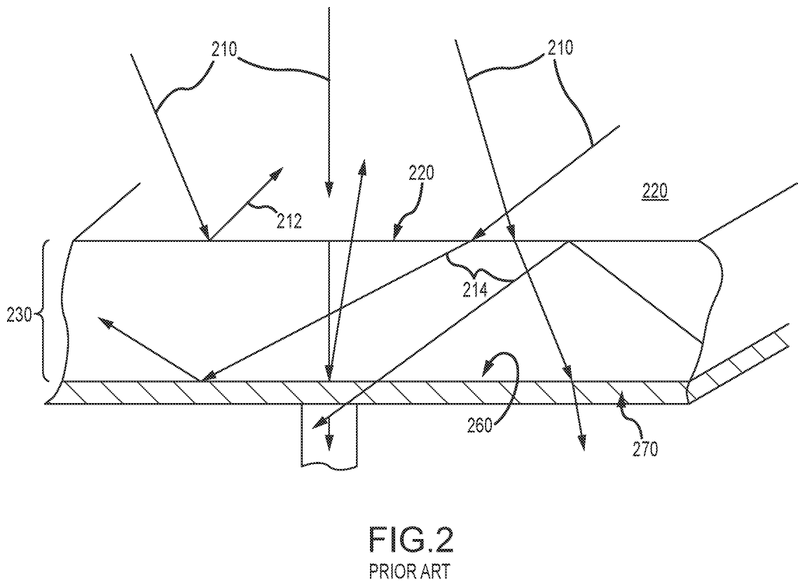

The high energy laser target board substrate system of the present invention includes a highly transparent substrate bonded to a substantially reflective coating. Recall, with reference to FIG. 1 and FIG. 2, radiation 110 striking a first surface 120 of a substrate 130 does so at an angle of incidence 140. The angle of incidence, AOI, is a measure of the angle from a line normal 150 to the surface 120 of the substrate, to the incoming ray or wave 110. In FIG. 1, a radiation wave 110 strikes the first surface 120 of a substrate at a first AOI 140 and, in this example, refracts and enters the substrate 130. Similarly, the now refracted wave 115, or a similar wave, transients the substrate 130, until it encounters the second surface 160 The radiation wave strikes the second surface at a different, unique AOI 165 based on refraction at the first surface 120. In this instance the wave 115 is now reflected rather than refracted and begins to travel upward 118 toward the first surface 120. As the wave 118 interacts with the first surface 120 it may again be reflected back toward the second surface 160 trapping the radiation within the substrate 130. It should also be appreciated that while FIG. 1, presents a single line as a wave, the reality of the interaction is that as the wave interacts with the surface various portions of the wave/ray have different AOIs with different degrees of reflection and refraction.

FIG. 2 is a cross-sectional representation of the interaction of one or more forms of radiation 210 interacting with a substrate 230 having a reflective layer 270, as would be known to one of reasonable skill in the relevant art. As discussed before, as radiation 210, such electromagnetic waves, or light from a high energy laser, interacts with the first surface 220 of a substrate 230, portions of the wave reflect away 212 from the surface. Other portions of the wave 210 experience refraction 214 at the surface 220. Recall refraction is the fact or phenomenon of light, radio waves, etc. being deflected in passing obliquely through the interface between one medium and another or through a medium of varying density. Refraction is the change in direction of propagation of any wave because of its traveling at different speeds at different points along the wave front.

In any substance there is an angle at which light (or radiation in general) is captured within the substrate. The waves continue to reflect within the material rather than refract and exit the substrate at the surface. This concept, often referred to as total internal reflection, is the principle on which fiber optic cables are based.

The substrate shown in FIG. 2 includes a reflective layer 270 bonded to the second surface 260. As would be appreciated by one of ordinary skill in the relevant art, a function of a reflective surface is to reflect a high percentage of the light interacting with the surface. Reflective surfaces are not, however, totally reflective. A certain amount of radiation traverses the reflective layer. In some instances, the radiation traversing the reflective area is measured by a sensor, camera, or the like. In other applications the radiation that traverse the reflective layer is merely lost.

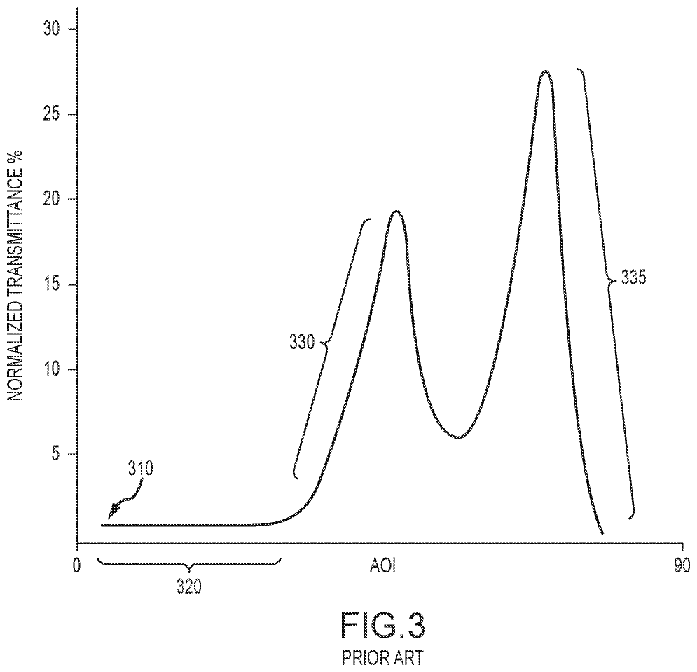

FIG. 3 is a graphical representation of normalized transmissivity of a reflective layer as would be known to one of reasonable skill in the relevant art. As would be expected, a large portion of radiation received at the reflective layer near the normal line is reflected. A small portion of the light however does make it through the reflective layer. In this example approximately 2% of light 310 interacting with the reflective layer from 0 to approximately 30 degrees AOI 320 is transmitted through the layer. However, at approximately 30 degrees of AOI and larger the amount of transmissivity 330 increases dramatically. Indeed, the transmissivity 335 of radiation of the reflective layer may be as high as 30% at an AOI of approximately 70 degrees. This degree of transmissivity, while inconsequential for most applications of a reflective layer, is unacceptable for detection and measurements of high energy lasers. This is because radiation approaching a sensor at 30 degrees or 70 degrees AOI may traverse the reflective layer at a higher percentage than that of zero degrees, making the measurements of the HEL unreliable.

Recall that a certain portion of radiation entering the substrate is trapped within due to internal reflection. A sensor calibrated to receive a small percentage of radiation received at a near normal AOI due to transmissivity of a reflective layer at those angles, provides inaccurate readings due to the influence of radiation trapped within the substrate and traversing the reflective layer at high angles of incidence.

The present invention enhances the reflectivity of the first and second surfaces while mitigating any ill effects due to trapped (crosstalk) radiation in the substrate to create a high energy laser target board substrate system that can continuously and accurately measure spatial and temporal HEL irradiance.

According to one embodiment of the present invention a substrate, substantially transparent to wavelengths of radiation under investigation includes a diffuse first surface and a reflective layer bonded to the second surface. Recall that a limiting factor of the measurement of radiance of a HEL is the ability to reliably and accurately reduce the energy from the HEL that reaches the sensor. The present invention predictably reduces the amount of energy from a HEL reaching a sensor while eliminating any ill effects due to transmittance of radiation trapped within the substrate.

One aspect of the present invention is a diffuse first surface of the substrate. Diffuse substrate surfaces are characterized by a roughness measurement wherein a greater roughness means the optical power spreads at greater angles as it passes through or reflects off the surface. The present invention incorporates a rough (diffuse) first surface of the substrate based on the anticipated wavelength of the HEL to spread out the received HEL

The first surface of the substrate incorporates a surface roughness to avoid specular reflections of a HEL beam. This is done, in one embodiment, by ensuring the roughness is comparable to the HEL wavelength. For example, at 1.06 um laser wavelength, the root mean squared (RMS) roughness measurement should be about 1 um. Roughness less than this amount may result in specular reflection that do not diverge significantly and therefore dangerous to laser operators or users of the target board system.

While the first surface of the substrate of the present invention is diffused to reflect away a certain portion of the HEL, the degree of diffusing, in one embodiment, is optimized to maximize reflectance yet minimize scattering of the laser beam before it engages the highly reflective coating on the back side of the substrate. As will be appreciated by one of reasonable skill in the relevant art, a large amount of scattering distorts the one or more sources of radiation making measurement difficult or impossible.

In another version of the present invention, the first surface of the substrate possesses a non-planar structure. The non-planar structure can be a pseudo-random surface designed to reflect and/or refract radiation divergently but not in a truly random fashion as in a diffuse surface. In this embodiment, the surface is designed to scatter or reflect a particular wavelength of radiation and minimize radiation that is transmitted into, and thereby trapped within, the width of the substrate. The first surface can be configured such that optical power reflects off this surface or does not refract at large angles beyond the angle of total internal reflection (e.g., refract at an angle smaller than the angle of total internal reflection thereby trapping the optical power). This surface may be patterned so that reflections of a laser beam are divergent thereby reducing in irradiance after reflection off of the target board. In such a consideration, the amount of transmissivity of the reflective layer at higher angles of incidence can be relaxed in favor of trapping the optical rays within the substrate.

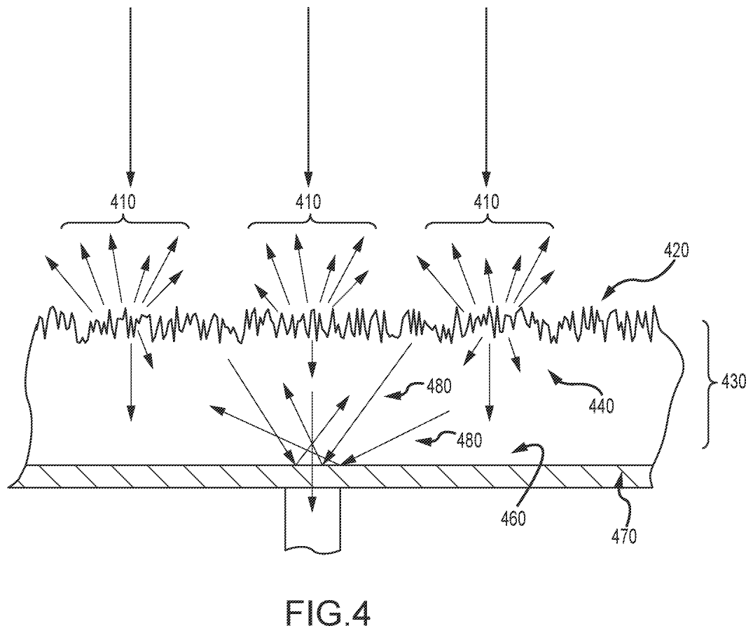

As shown in FIG. 4, one aspect of the present invention is the use of a diffuse surface 420 that scatters 410, 430 optical power on the surface into the thickness 440 of the substrate such that the angle of the light rays is greater than the glass air interface critical angle. Such light rays are effectively trapped within the window eliminating a cause of erroneous measurements. The present invention includes a minimal roughness at the window entrance to reduce the number of trapped rays but sufficient roughness that also avoids specular reflections.

The substrate 430 medium itself is substantially transparent to the one or more forms of radiation. In one embodiment of the present invention the substrate 430 comprises amorphous silicon dioxide. In another version of the present invention the amorphous silicon dioxide is manufactured by flame hydrolysis resulting in a highly transmissible substrate. Indeed, the transmissibility of the substrate for wavelengths 1030-1080 nm is substantially 100%. In other versions of the invention, the transmissibility of the substrate for wavelengths 1000-2250 nm is substantially 100%. The purity of the substrate also results in little to no energy absorption of the HEL aiding the ability of the high energy laser target board substrate system to operates continuously under HEL exposure. Other fused silica material and the like providing comparable transparent characteristics are compatible with and within the scope of the present invention and are indeed contemplated based on the target wavelength range of the one or more sources radiation.

Another feature of the present invention is the thickness of the substrate 430. A thicker substrate result in greater beam spreading after passing through the thickness of the substrate. Spreading reduces measurement accuracy. The present invention optimizes substrate thickness based on contributing factors such system weight, strength, and target board accuracy.

A reflective layer 470, bonded to the second surface 460 of the substrate 430 exhibits consistent and predictable transmissivity. According to one embodiment of the present invention, the reflective layer 470 bonded to the second surface 460 of the substrate 430 is configured to provide a normalized transmissivity less than that of its normal transmissivity as the angle of incidence increases. For example, the reflect layer can be configured to have a first level of transmissivity at a zero-degree angle of incidence greater than 0.0%. And the level of transmissivity as the angle of incidence increases from zero degrees to ninety degrees is less than the first level of transmissivity. For example, assume the level of transmissivity at the zero degree of angle incidence is 0.2%. For each angle greater than zero degrees angle of incidence, the transmissivity of the reflective layer is less than 0.2%.

In one embodiment the transmissivity of the reflective layer at zero degrees angle of incidence (normal) is approximately 0.3%. In another embodiment of the present invention, the transmissivity of the reflective layer at zero degrees angle of incidence (normal) is no greater than 0.4% and no less than 0.25%. As angle of incidence increases, the percentage of transmissivity decreases eliminating any ill effects due to substrate trapped radiation (crosstalk) 480. Indeed, in one embodiment the upper limit of transmissivity decreases from 0.4% at 25 degrees of incidence to 0.05% at 45 degrees. And at 45 degrees to 90 degrees angle of incidence the upper limit of transmissivity continues to degrees from 0.05% to 0.02%. The lower limit of transmissivity decreases from 0.25% at 25 degrees to zero at 45 degrees and thereafter. In doing so effects of radiation crosstalk within the substrate are eliminated.

In another embodiment, the reflective layer can include a high index of refraction. It may also be configured as at highly absorbing layer. In either case the layer eliminates trapped rays.

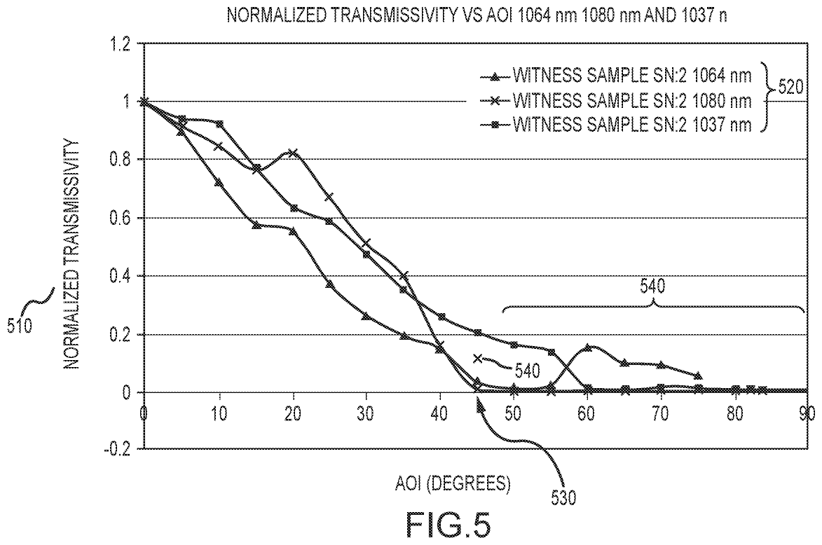

FIG. 5 presents a normalized graphical plot of normalized transmissivity 510 for the high energy laser target board substrate system of the present invention for wavelength samples of 1037, 1064 and 1080 nm 520. In each case the transmissivity of the selected wavelength begins at 1.0 for zero degrees of incidence. Recall that the actual measure of transmissivity at zero degrees of incidence is approximately 0.2%. In each case, the normalized degree of transmissivity decreases as the angle of incidence increases. At approximately an angle of incidence of 45 degrees 530 the normalized transmissivity is 0.01 540 of that what it was at zero degree of incidence.

The highly reflective coating on the second surface of the substrate, according to one embodiment of the present invention, overall reflects a large percentage of optical power of the HEL at low AOIs while transmitting the remainder with minimal absorption. The transmitted portion of the HEL is thereafter used for HEL measurement by a sensor, diode, cameral or the like. In one embodiment the substrate is configured to limit the transmission of HEL to avoid excessive heating of the sensor system yet allow enough power to allow high dynamic range of sensing. Moreover, the low transmissivity at high AOIs 540 ensure HEL measurements are not adversely impacted by radiation crosstalk.

The highly reflective layer bonded to the second surface of the substrate is comprised, in one embodiment of a plurality of dielectric layers. Manipulating the layers provides a multi-layer coating for which transmissivity at various angles of incidence is configurable which can change dramatically over the full range of possibilities. For example, in one embodiment a reflective layer can reflect 99.6% of the optical power at normal (0 degrees) and therefore transmitting almost all the remaining, 0.4% optical power at normal, while reflecting almost all of the optical power at angles from 30-90 degrees AOI.

It is undesirable to have any significant amount of optical power transmitted through the window at large angles of incidence. Accordingly, the coatings of the present invention are configured to have low transmissivity at large angles of incidence. Transmissivity at normal is 0.4%, with transmissivity of 0.01% at 80 degrees and above is obtainable.

Combining a diffuse first surface, with a highly transparent substrate having a bonded reflective layer creates a high energy laser target board system that is accurate, reliable, and durable. Managing the degree of transmissivity of radiation that reaches an underlying sensor from the first point at which the radiation interacts with the substrate yields a system that provides accurate and reliable HEL temporal and spatial measurement capabilities.

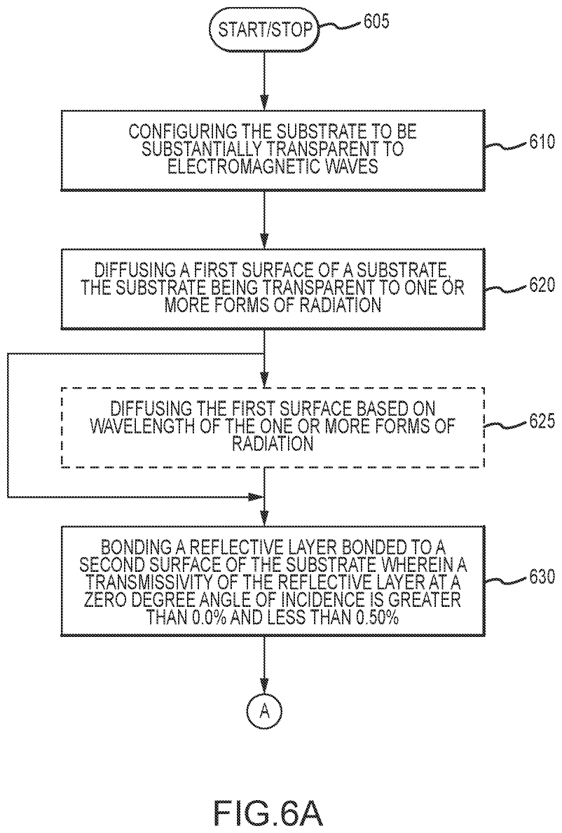

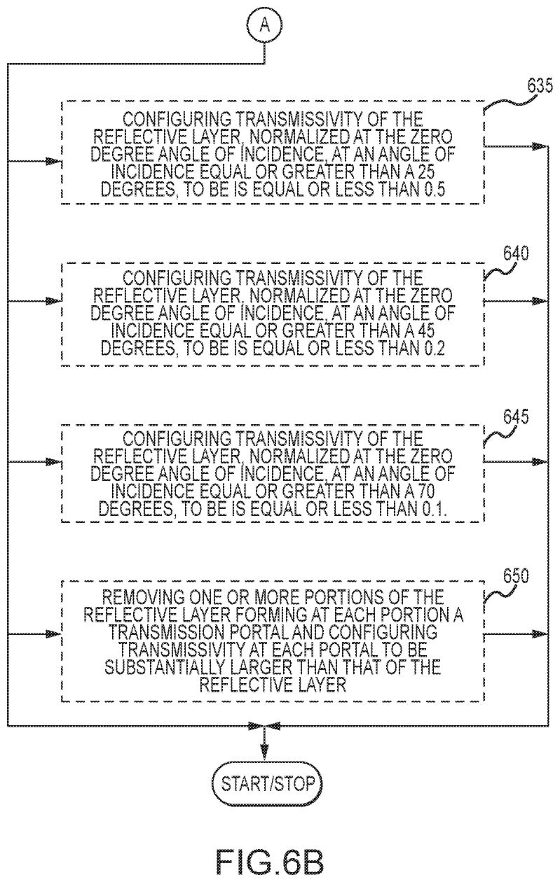

FIGS. 6A and 6B provide a flowchart depicting examples of the methodology which may be used to manufacture the high energy laser target board substrate system of the present invention. In the following description, it will be understood that each block of the flowchart illustrations, and combinations of blocks in the flowchart illustrations, can be implemented by hardware, firmware, computer program instructions or a combination thereof. With respect to computer programs, these instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware or hardware-based computer systems that perform the specified functions or steps, or combinations of special purpose hardware and computer instructions.

A method for manufacturing a high energy laser target board substrate system of the present invention begins 605 with diffusing 620 a first surface of a substrate. The substrate configured 610 to be highly transparent to one or more forms of radiation. In one embodiment of the present invention, the substrate comprises amorphous silicon dioxide. In another version of the present invention the amorphous silicon dioxide is manufactured by flame hydrolysis resulting in a highly transmissible substrate.

The first surface of the substrate that interacts with an incoming source of radiation (HEL) incorporates a diffuse surface or roughness to avoid specular reflections. The roughness 625 is configured, in one embodiment, based on the incoming wavelength.

Bonding 630 a reflective layer (or layers) to the second surface of the substrate described above forms the high energy laser target board substrate system of the present invention. In one embodiment the transmissibility (normalized at the zero-degree angle of incidence) of the reflective layer is configured 635 to be, at an angle of incidence greater than 25 degrees, less than 0.5. In another embodiment, the relative transmissibility of the reflective layer is configured 640 to be, at an angle of incidence greater than 45 degrees, less than 0.2. And in yet another embodiment of the present invention, the relative transmissibility of the reflective layer is configured 645 to be, at an angle of incidence greater than 70 degrees, less than 0.1.

Another version of the present invention places a high index absorption layer (not shown) on top (toward the interior of the substrate) of the highly reflective later of the second surface. The high index absorption layer eliminates radiation that is otherwise trapped within the substrate that may propagate at high angles and may influence or alter sensor readings.

In another embodiment of the present invention, transmissivity of the one or more forms of radiation is enhanced by removing 650 portions of the reflective layer, forming portals. The transmissivity of the portal is configured to be substantially larger than that of the entire reflective layer. For example, if the reflective layer comprised 4 layers of dielectric material forming the desired transmissivity characteristics, one or more layers may be removed at certain locations, forming a portal of known size and location, which provides higher transmissivity. By configuring a series of portals in a known configuration the breadth (dimensions) of the HEL can be determined as can variances in power level. In one embodiment portals may be circular in shape having a diameter on the order of 10 um. Moreover, such a configuration can be used in conjunction with, or as an alternative to, requiring low transmissivity at higher angles of incidence.

The high energy laser target board substrate system of the present invention comprises a high-quality substrate with a diffuse front (first) surface and a reflective back (second) surface. The roughness of the first surface is neither too high to cause excessive light scattering or too low to cause specular reflections. The substrate is dimensioned to facilitate manufacturing while minimizing beam distortion that will occur through needlessly thick material. The reflective layer on the second surface is configured to provide sufficient transmissivity at normal angles to be useful to a variety of measurement components, as would be known to one of average skill in the relevant art. The present invention is configured to provide high reflectivity with low absorption. Transmissivity of the HEL (one or more forms of radiation) substantialy drops as the angle of the incidence increases. Indeed, at relatively low angles, 25 degrees from normal and larger, transmissivity continually decreases.

While there have been described above the principles of the present invention in conjunction with a high energy laser target board substrate system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se, and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A high energy laser target board substrate system, the substrate system comprising;
a substrate transparent to one or more forms of radiation wherein the substrate includes a first surface and a second surface, wherein the first surface is a diffuse surface; and
a reflective layer bonded to the second surface of the substrate wherein transmissivity of the reflective layer at an angle of incidence of zero degrees is a first transmissivity level greater than 0.0% and wherein transmissivity of the reflective layer from the angle of incidence of zero degrees to ninety degrees is less than the first transmissivity level.

2. The high energy laser target board substrate system of claim 1, wherein the first transmissivity level at the angle of incidence of zero degrees is less than 0.5%.

3. The high energy laser target board substrate system of claim 1, wherein the one or more forms of radiation include energy traveling in the form of an electromagnetic wave.

4. The high energy laser target board substrate system of claim 3, wherein the electromagnetic wave has a wavelength between 1030 nm and 1080 nm.

5. The high energy laser target board substrate system of claim 1, wherein the one or more forms of radiation include photons.

6. The high energy laser target board substrate system of claim 1, wherein the one or more forms of radiation reflected from the first surface of the substrate is independent from an angle of incidence between the one or more forms of radiation and the first surface of the substrate.

7. The high energy laser target board substrate system of claim 6, wherein a degree of roughness of the diffuse surface is based on the wavelength of the one or more forms of radiation.

8. The high energy laser target board substrate system of claim 1, wherein the substrate comprises amorphous silicon dioxide.

9. The high energy laser target board substrate system of claim 1, wherein a relative transmissivity of the reflective layer, normalized at the zero-degree angle of incidence, at an angle of incidence equal or greater than 25 degrees is equal or less than 0.5.

10. The high energy laser target board substrate system of claim 9, wherein a relative transmissivity of the reflective layer, normalized at the zero-degree angle of incidence, at an angle of incidence equal to or greater than 45 degrees is equal to or less than 0.2.

11. The high energy laser target board substrate system of claim 10, wherein a relative transmissivity of the reflective layer, normalized at the zero-degree angle of incidence, at an angle of incidence equal to or greater than 70 degrees is equal to or less than 0.1.

12. The high energy laser target board substrate system of claim 1, wherein one or more portions of the reflective layer is removed forming at each portion a transmission portal and wherein transmissivity at each portal is substantially larger than that of the reflective layer.

13. The high energy laser target board substrate system of claim 1, wherein the first surface is a pseudo random structure configured to reflect optical power off the first surface or refract optical power at an angle smaller than an angle of total internal reflection.

14. A method for manufacturing a high energy laser target board substrate system, the method comprising:
diffusing a first surface of a substrate, the substrate being transparent to one or more forms of radiation; and
bonding a reflective layer bonded to a second surface of the substrate wherein transmissivity of the reflective layer at an angle of incidence of zero-degrees is a first transmissivity level greater than 0.0% and wherein the transmissivity of the reflective layer from the angle of incidence of zero degrees to ninety degrees is less than the first transmissivity level.

15. The method for manufacturing a high energy laser target board substrate system according to claim 14, wherein the first transmissivity level is less than 0.50%.

16. The method for manufacturing a high energy laser target board substrate system according to claim 14, wherein the substrate comprises amorphous silicon dioxide.

17. The method for manufacturing a high energy laser target board substrate system according to claim 14, further comprising configuring the reflective layer to have a relative transmissivity, normalized at a zero-degree angle of incidence, at the angle of incidence equal or greater than 25 degrees equal to or less than 0.5.

18. The method for manufacturing a high energy laser target board substrate system according to claim 14, further comprising configuring the reflective layer to have a relative transmissivity, normalized at a zero-degree angle of incidence, at the angle of incidence equal to or greater than 45 degrees equal to or less than 0.2.

19. The method for manufacturing a high energy laser target board substrate system according to claim 14, further comprising configuring the reflective layer to have a relative transmissivity, normalized at a zero-degree angle of incidence, at the angle of incidence equal to or greater than 70 degrees equal to or less than 0.1.

20. The method for manufacturing a high energy laser target board substrate system according to claim 14, further comprising removing one or more portions of the reflective layer forming at each portion a transmission portal and configuring transmissivity at each portal to be substantially larger than that of the reflective layer.

21. The method for manufacturing a high energy laser target board substrate system according to claim 14, further comprising configuring the substrate to be substantially transparent to electromagnetic waves having a wavelength between 1030 nm and 1080 nm.

22. The method for manufacturing a high energy laser target board substrate system according to claim 14, further comprising configuring the first surface of the substrate to reflect the one or more forms of radiation independent from an angle of incidence between the one or more forms radiation and the first surface of the substrate.

23. The method for manufacturing a high energy laser target board substrate system according to claim 22, wherein diffusing the first surface is based on wavelength of the one or more forms of radiation.

24. The method for manufacturing a high energy laser target board substrate system according to claim 14, further comprising configuring the first surface with a pseudo random structure to reflect optical power off the first surface or refract optical power at an angle smaller than an angle of total internal reflection.
